(19) United States
(12) Patent Application Publication
(10) Pub. No.: US 2015/0106188 A1
(43) Pub. Date: Apr. 16, 2015

(54) MERCHANT FUNDED REWARDS PROGRAM

(71) Applicant: fisoc, Inc., Austin, TX (US)

(72) Inventors: Jay P. Valanju, Austin, TX (US); Daniel Edward Kim, Austin, TX (US); David H. Fruhling, II, Austin, TX (US); Brian Rainey, Austin, TX (US)

(73) Assignee: fisoc, Inc., Austin, TX (US)

(21) Appl. No.: 14/152,339

(22) Filed: Jan. 10, 2014

Related U.S. Application Data
(60) Provisional application No. 61/891,027, filed on Oct. 15, 2013.

(51) Int. Cl. G06Q 30/02

(52) U.S. Cl. CPC G06Q 30/0227
USPC 705/14.28

(57) ABSTRACT

A merchant funded rewards program for a participating entity enables merchants to become member merchants by registering with the program and receives transaction data from the participating entity. Reward points are provided to customers of the participating entity according to parameters defined by the member merchants based on the transaction data. Fees are charged to the member merchants for the rewards points.

### CROSS-REFERENCES TO RELATED APPLICATIONS

This application claims the benefit of U.S. Provisional Patent Application Ser. No. 61/891,027, filed Oct. 15, 2013, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

With narrowing interchange revenues, financial institutions (FIs) are having more and more difficulty supporting debit reward programs. In addition, many debit rewards programs are dependant on redemption breakage (the rate at which rewards are earned and not redeemed versus earned and never redeemed). Because of this reliance on breakage, there is an incentive for FIs to socialize their rewards program pre-signup, but to discourage usage post-signup. This has resulted in historically low penetration rates. If the balance of penetration versus redemptions is not correct, the overhead associated with such programs dominates the cost, and the program ends up being highly unprofitable for the FIs. Many programs try to alleviate this problem by marketing a “merchant funded” program, but for many smaller FIs, the critical mass of merchants versus population never arrives, and the program continues to be unprofitable and unsustainable.

### BRIEF SUMMARY OF THE INVENTION

The solution to this problem is to change the economics of the program so that breakage is no longer the key focus of program profitability. By incentivizing a specific combination of behaviors, the program is able to generate positive revenue for all parties regardless of breakage. Specifically, by providing merchants with customer targeting tools, point of sale incentive programs (repeat customer programs) and gift card services, the shift towards targeted marketing (versus traditional media spend) enables a higher per user spend level while potentially decreasing total marketing cost. This spend, captured by the provider of the program, can then be shared with an FI to provide a new revenue stream. When combined increases in interchange revenue, driven higher through specific behavior targeting through the design of the program (incentivizing merchant and transaction types of higher value to the FI), as well as decreases in costs for the FI (incentivizing cost saving behaviors, such as enrollment in e-statements), the program provides increases in net profit while remaining agnostic to breakage revenue. Additionally, the program is able to layer multiple FIs in a single community to provide potential customers of merchants and also merchant lead lists (through their commercial relationships) with a global merchant network.

In an exemplary embodiment, a method of administering a merchant funded rewards program for a participating entity includes the steps of (a) enabling merchants to become member merchants by registering with the program; (b) receiving transaction data from the participating entity; (c) providing reward points to customers of the participating entity according to parameters defined by the member merchants based on the transaction data; and (d) charging fees to the member merchants for the rewards points. Step (a) may be practiced by charging a directory fee to the merchants.

Step (b) may be practiced by receiving the transaction data after one of the customers of the participating entity conducts a transaction with one of the member merchants, and step (c) may be practiced by computing the reward points based on the transaction data. The method may also include sharing the fees paid by the member merchants with the participating entity.

In one arrangement, the method includes defining a business category for the member merchants, and defining a campaign for the member merchants to market goods and services to customers of the participating entity that conduct or are likely to conduct transactions in the business category. In this context, step (b) may comprise receiving transaction data from the participating entity relating to customer transactions conducted in the business category with competitor merchants that are competitors of the member merchants. The step of defining a campaign may include defining a competitor campaign for the member merchants to market goods and services to the customers of the participating entity that complete a transaction with one of the competitor merchants. The step of defining a campaign may alternatively include defining a business campaign for the member merchants to offer increased reward points as an incentive to increase a purchasing frequency or an average spending amount of the participating entity customers.

In one embodiment, the participating entity is a financial institution. In this context, step (b) may be practiced by receiving transaction data from the participating entity for transactions conducted by the participating entity customers using a debit card.

In another exemplary embodiment, a system for administering a merchant funded rewards program for a participating entity includes a system server and network communication hardware. The system server includes a processor and a memory, where the memory stores software executed by the processor that enables merchants to become member merchants by registering with the program. The network communication hardware is cooperable with the processor and communicates with a global network. The network communication hardware receives transaction data from the participating entity. The software is executed by the processor to provide reward points to customers of the participating entity according to parameters defined by the member merchants based on the transaction data, and the software is executed by the processor to charge fees to the member merchants for the rewards points.

In still another exemplary embodiment, a method of monetizing transaction data derived from customers of a financial institution using merchant funded rewards from member merchants includes the steps of (a) receiving the transaction data from the financial institution; (b) providing reward points to the customers of the financial institution according to parameters defined by the member merchants based on the transaction data; and (c) charging fees to the member merchants for the rewards points.

### BRIEF DESCRIPTION OF THE DRAWINGS

These and other aspects and advantages will be described in detail with reference to the accompanying drawings, in which:

FIG. 1 is a schematic diagram showing the participants in the merchant funded rewards program;

FIG. 2 is a process diagram showing a revenue split for the merchant funded rewards program;

FIG. 3 is a process diagram showing the revenue split for listing and non-recurring revenue; and

FIG. 4 is a detailed schematic illustration of a computer system.

### DETAILED DESCRIPTION OF THE INVENTION

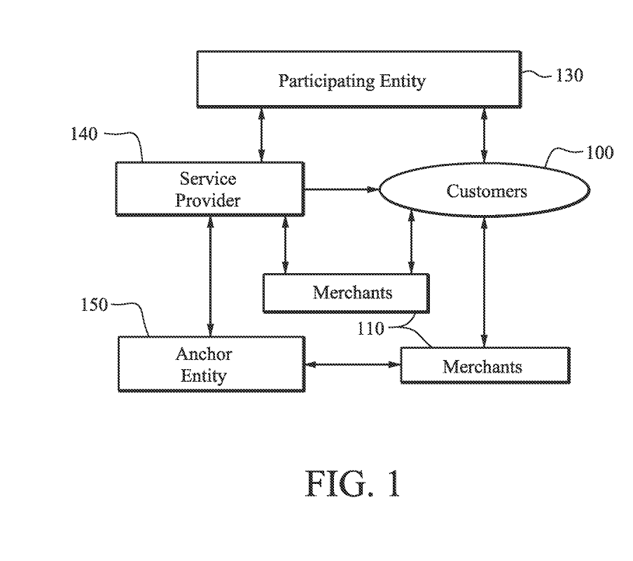

With reference to FIG. 1, a service provider 140 administers a merchant funded rewards program for a participating entity 130 such as a financial institution. Customers 100 of the participating entity 130 are offered reward points and the like for particular behavior, and from the participating entity customers' perspective, the reward points are provided by the participating entity 130. The service provider 140 administers as a “silent” partner to the participating entity 130, typically without knowledge of the participating entity customers 100.

Merchants 110 are those entities that sell products and services to consumers. In the case of the participating entity 130 being a financial institution, the financial institution has access to spending habits and the like of its customers 100. The transaction data from customer purchases can be utilized to provide direct or targeted marketing of merchant goods and services to customers of the financial institution based on available transaction data.

Merchants 110 may be identified by the service provider 140 and/or by outside referrals through one or more anchor entities 150. An anchor entity 150 may contract with the service provider 140 for its member merchants 110 to participate in the rewards program, or the merchants 110 can contract directly with the service provider 140.

In administering the merchant funded rewards program, the service provider 140 provides a vehicle to enable merchants to become member merchants 110 by registering with the program. Registration can be achieved in any known manner, typically utilizing an online registration process and including suitable contracts and agreements with regard to participation in the rewards program.

The service provider 140 receives transaction data from the participating entity 130 via known network protocol and network communication hardware. The transaction data may be received after one of the customers 100 of the participating entity 130 conducts a transaction inside or outside of the merchant network (including member merchants) 110. The reward points are computed based on the transaction data. The service provider 140 processes the transaction data and provides reward points to customers 100 of the participating entity 130 according to parameters defined by the member merchants 110 and possibly also the participating entity 130 based on the transaction data. The service provider 140 charges fees to the member merchants for the reward points awarded. It should be appreciated that financial institutions, in addition to being participating entities, may also act as merchants for purposes of promoting financial institution products (e-statements, skip a pay, short term loans, home equity line of credit, etc.). In these instances, the financial institutions would also be charged fees for rewards points awarded to customers.

Reference to “reward points” is exemplary and is intended to reference anything of value that may be desirable to a consumer. Reward points may be “cashed in” for value such as gift cards, products, frequent flyer miles, etc.

The rewards program is beneficial to merchants 110 for marketing and business development. Specifically, the rewards program can be utilized to define campaigns for identifying new customers and target offers to customers of competitor merchants. Campaigns can also be defined using the rewards program to increase the average spend amount for existing customers and/or to increase the shopping frequency of existing customers. In this context, when a member merchant 110 registers with the program, the member merchant 110 can identify a business category relating to the member merchant goods and services. In the rewards program, the service provider 140 can assist the member merchant 110 in defining a campaign for the member merchants to market goods and services to customers 100 of the participating entity 130 that conduct or are likely to conduct transactions in the business category. For example, when receiving the transaction data, the data from the participating entity 130 may relate to customer transactions conducted in the business category with competitor merchants that are competitors of the member merchants 110. The member merchants 110 can offer reward points (e.g., “triple points”) to the customers of the competitor merchants for future business. Alternatively or additionally, a business campaign may be defined for the member merchants 110 to offer increased reward points as an incentive to increase a purchasing frequency or an average spending amount of the participating entity customers 100. For example, additional reward points may be offered by the member merchant 110 for participating entity customers 100 that spend more than $100.00 in a single transaction.

With the participating entity 130 as a financial institution, the transaction data may be limited to transactions conducted by the participating entity customers 100 using a debit card or a credit card.

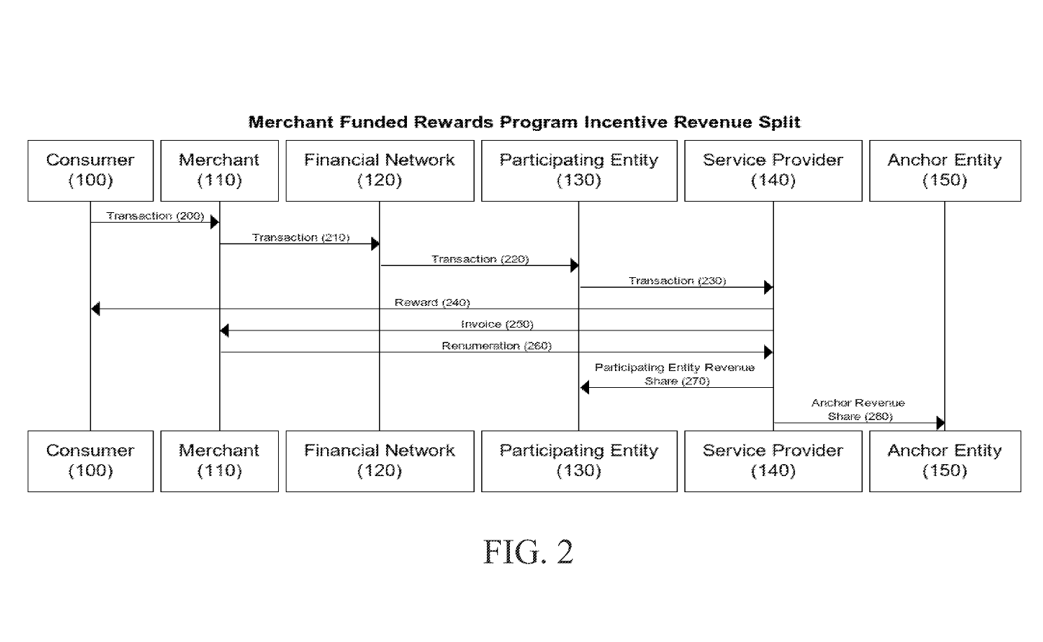

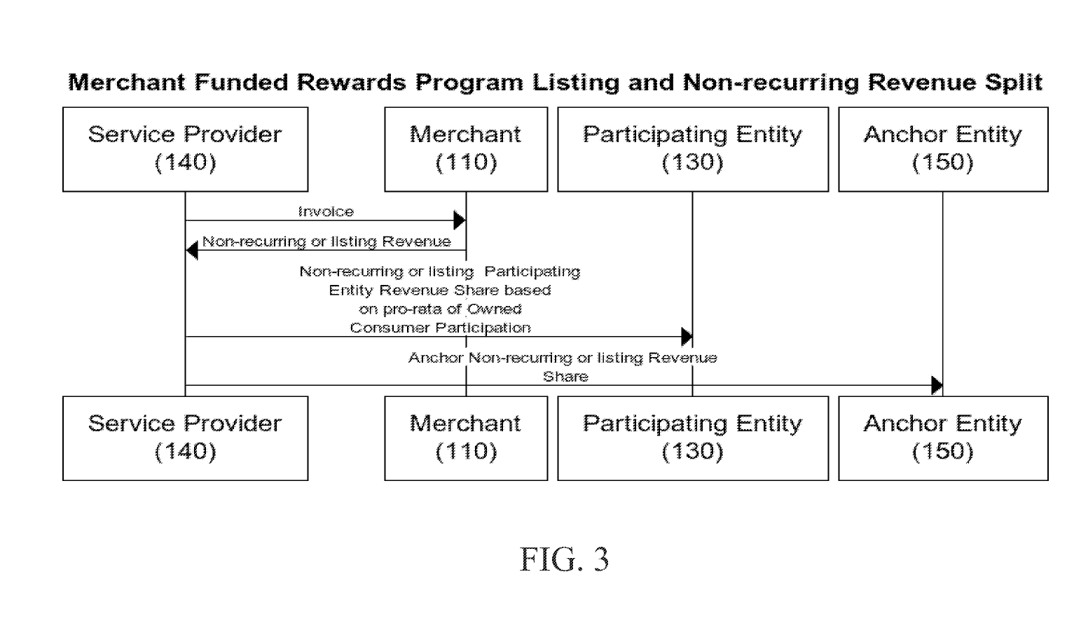

Processing revenue from the merchant will be described with reference to FIGS. 2 and 3. Revenue coming from a merchant comes in three forms: recurring listing revenue fees, reward costs (in points, goods, or services); and ad hoc non-recurring revenue, such as individual email costs or promotions. Merchant revenues are split between the service provider and the participating entity (e.g., FI). The service provider 140 is the entity who handles the servicing of the ecosystem. FIs can include an anchor entity 150, which owns the contract with the member merchant 110, and the participating entity 140, which owns the contract with the customers 100.

When a consumer 100 on the program makes a purchase 200 at a merchant 110 in the financial network 120 (giving rise to transaction derived revenue), the transaction 210 information flows through the network 120 and ends up 220 at the participating entity 130. As noted, this is typically the retail FI that the consumer is a member of, but may be defined as any institution that can provide the required transaction data to enable the rewards program.

The participating entity provides the data 230 to the service provider 140. The service provider computes the reward or incentive 240 to be awarded to the consumer 100. Awards can include points or other incentives, such as special offers, goods, or services. At regular or instantaneous intervals, the invoice 250 is delivered to the member merchant 110. When the merchant pays the invoice 260, the resulting revenue is split among the service provider, participating entity and the anchor entity 150, as applicable. The anchor entity can be the same as the participating entity, the service provider, or an entirely different entity, and is not limited to one entity alone. The revenue for the participating entity is calculated as a share of the revenue generated by the original consumer if and only if the consumer relationship is owned by the participating entity 270. The revenue 280 for the anchor entity is calculated by a fixed percentage of the recurring revenue collected from the merchant caused by the original consumer transaction.

The listing and non-recurring revenue (non-transaction derived) split is calculated in a similar way. When an invoice to a merchant 110 is delivered, both transaction and non-transaction derived revenue is listed.

One time charges can include the following: setup costs or initial capital expenditure cost (for example, equipment); individual advertising campaign charges; promotional giveaway charges; etc. Listing charges can be any recurring non-variable cost such as a monthly directory listing or equipment rental fee. When the invoice is paid (merchant 110 to service provider 140), the participating entity 130 is entitled to a portion of that revenue dictated by the total share of listing and non-recurring revenue prorated to the share of activity derived from consumers owned by the participating entity. The anchor entity revenue split is a static percentage of revenue.

The program can be modified by splitting the listing and the non-recurring revenue into separate buckets, and percentages can be adjusted to zero if the program needs simplification. For the program to be completely merchant funded, the share of the revenue that the organization or entity participates in must equal or exceed the operational cost of the program. The service may or may not choose to roll the cost of operations into an accounts payable pool where future earning can be netted against.

The rewards program described with reference to FIGS. 1-3 is preferably a browser-based system in which a program running on a user's computer (the user's web browser) requests information from a server program running on a system server. The system server sends the requested data back to the browser program, and the browser program then interprets and displays the data on the user's computer screen. The process is as follows:

1. The user runs a web browser program on his/her computer.

2. The user connects to the server computer (e.g., via the Internet). Connection to the server computer may be conditioned upon the correct entry of a password as is well known.

3. The user requests a page from the server computer. The user's browser sends a message to the server computer that includes the following:
the transfer protocol (e.g., http://); and
the address, or Uniform Resource Locator (URL).

4. The server computer receives the user's request and retrieves the requested page, which is composed, for example, in HTML (Hypertext Markup Language).

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the account management system of the present invention include Mozilla Firefox® and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the system described below and illustrated in the accompanying drawings.

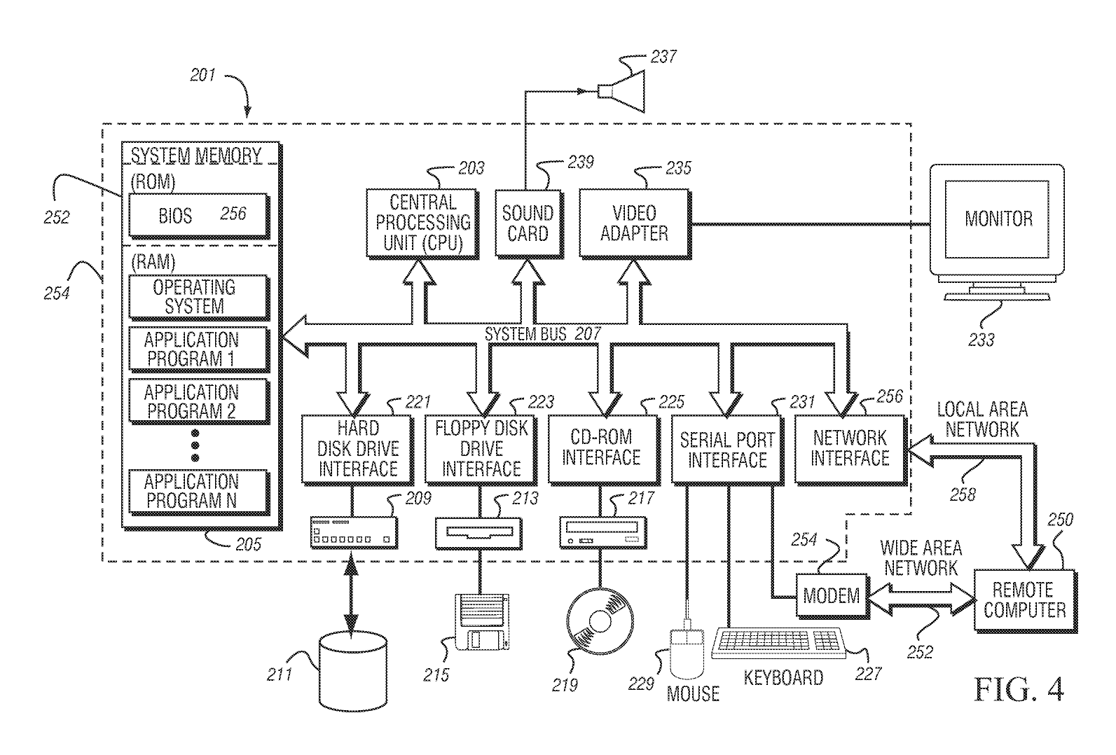

FIG. 4 generally illustrates a computer system 201 suitable for use as the client and server components of the described system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem or broadband or wireless adapter 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

The merchant funded rewards program of the preferred embodiments changes the economics of existing programs so that breakage is no longer the key focus for program profitability. The program incentivizes a specific combination of behaviors to generate positive revenue for all parties regardless of breakage. With combined increases in interchange revenue, driven higher through specific behavior targeting through the design of the program, as well as decreases in costs for the participating entity, the program provides increases in net profit regardless of breakage revenue.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of administering a merchant funded rewards program for a participating entity, the method comprising:
(a) enabling merchants to become member merchants by registering with the program;
(b) receiving transaction data from the participating entity;
(c) providing reward points to customers of the participating entity according to parameters defined by the member merchants based on the transaction data; and
(d) charging fees to the member merchants for the rewards points.

2. A method according to claim 1, wherein step (a) is practiced by charging a directory fee to the merchants.

3. A method according to claim 1, wherein step (b) is practiced by receiving the transaction data after one of the customers of the participating entity conducts a transaction with one of the member merchants, and wherein step (c) is practiced by computing the reward points based on the transaction data.

4. A method according to claim 3, further comprising sharing the fees paid by the member merchants with the participating entity.

5. A method according to claim 1, further comprising defining a business category for the member merchants, and defining a campaign for the member merchants to market goods and services to customers of the participating entity that conduct or are likely to conduct transactions in the business category.

6. A method according to claim 5, wherein step (b) comprises receiving transaction data from the participating entity relating to customer transactions conducted in the business category with competitor merchants that are competitors of the member merchants.

7. A method according to claim 6, wherein the step of defining a campaign comprises defining a competitor campaign for the member merchants to market goods and services to the customers of the participating entity that complete a transaction with one of the competitor merchants.

8. A method according to claim 5, wherein the step of defining a campaign comprises defining a business campaign for the member merchants to offer increased reward points as an incentive to increase a purchasing frequency or an average spending amount of the participating entity customers.

9. A method according to claim 1, wherein the participating entity is a financial institution.

10. A method according to claim 9, wherein step (b) is practiced by receiving transaction data from the participating entity for transactions conducted by the participating entity customers using a debit card.

11. A system for administering a merchant funded rewards program for a participating entity, the system comprising:
a system server including a processor and a memory, the memory storing software executed by the processor that enables merchants to become member merchants by registering with the program; and
network communication hardware cooperable with the processor and communicating with a global network, the network communication hardware receiving transaction data from the participating entity,
wherein the software is executed by the processor to provide reward points to customers of the participating entity according to parameters defined by the member merchants based on the transaction data, and wherein the software is executed by the processor to charge fees to the member merchants for the rewards points.

12. A method of monetizing transaction data derived from customers of a financial institution using merchant funded rewards from member merchants, the method comprising:
(a) receiving the transaction data from the financial institution;
(b) providing reward points to the customers of the financial institution according to parameters defined by the member merchants based on the transaction data; and
(c) charging fees to the member merchants for the rewards points.

13. A method according to claim 12, wherein step (a) is practiced by receiving the transaction data after one of the customers of the financial institution conducts a transaction with one of the member merchants, and wherein step (b) is practiced by computing the reward points based on the transaction data.

14. A method according to claim 13, further comprising sharing the fees paid by the member merchants with the financial institution.

15. A method according to claim 12, further comprising defining a business category for the member merchants, and defining a campaign for the member merchants to market goods and services to customers of the financial institution that conduct or are likely to conduct transactions in the business category.
